(19) United States
(12) Patent Application Publication
(10) Pub. No.: US 2023/0409521 A1
(43) Pub. Date: Dec. 21, 2023

(54) AUTOMATIC PRESERVATION

(71) Applicant: Preservica Ltd, Abingdon (GB)

(72) Inventors: Jonathan Tilbury, Abingdon (GB); Jack O'Sullivan, Abingdon (GB); Richard Smith, Abingdon (GB)

(21) Appl. No.: 17/825,568

(22) Filed: May 26, 2022

(51) Int. Cl. G06F 16/11; G06F 16/23

(52) U.S. Cl. CPC G06F 16/116; G06F 16/125; G06F 16/2358

(57) ABSTRACT

A computer-implemented method of automatically preserving digital documents stored in a digital preservation system. The method comprises receiving an indication of a change to at least one of configuration data or tools of the digital preservation system, processing the indication to determine at least one affected asset which is stored by the digital preservation system and is affected by the change, determining at least one action to be performed by a tool of the preservation system on the at least one affected asset.

### TECHNICAL FIELD

This invention relates to computer-implemented methods for preservation of digital data and in particular to automatic preservation of digital documents stored in a digital preservation system.

### BACKGROUND

As recently as 2019 it has been estimated that the majority of the word's data was generated in the preceding two years and that 2.5 quintillion bytes of data is created each day. The overwhelming majority of that data is stored digitally. In addition to the rate of data generation, the environment in which that data is stored is highly dynamic. New file formats are regularly created to encode data (such as the HEIC image format) and existing formats may be updated to improve performance or address faults. Within this dynamic environment, digital data can become lost or unreadable. Old formats may become unreadable as tools used to create, view or edit those formats become obsolete and fall out of use. Some information may be required for access long after creation, but it is likely that file formats in widespread use at the time of content creation will not be in use at a desired time of access, maybe tens or hundreds of years later.

While solutions such as storage and back-up can prevent some hardware-related issues such as bit-decay (or bit-rot), the dynamic environment in which digital data is produced, stored and edited means that storage and back-up cannot mitigate all causes of loss of access to digital data. Digital preservation refers to activities performed to ensure continued availability of access to digital data and refers to all of the actions required to maintain access to digital materials beyond the limits of media failure or technological and organisational change.

Digital preservation systems often include elaborate strategies to ensure information is in formats that are appropriate to their use. Such processes are documented in ISO 14721 “Open archival information system (OAIS)—Reference model”. However, these strategies currently require significant expert user management. They also do not allow for change as the tools that perform these processes and the information required to determine appropriate actions inevitably changes.

### SUMMARY

To address at least the above-described technological problems with digital preservation systems and digital data, embodiments described herein provide systems and methods for automatically detecting a change to a digital preservation system, automatically determining at least one asset stored in the digital preservation system that is affected by the change, and automatically determining at least one action to be performed by a tool of the preservation system on the at least one affected asset. The at least one action comprises at least one selected from a group consisting of: migration of the at least one asset from one format to another format; processing the at least one asset to determine and store properties of the at least one asset; and validation that the at least one asset complies with a format specification for an indicated format of the asset. The at least one action limits loss of access to digital data that otherwise results from changes to digital preservation systems and, thus, improves the functioning of a computer or a data preservation system and represents an improvement in technology.

There is described herein a computer-implemented method of automatically preserving digital documents stored in a digital preservation system. The method comprises receiving, at one or more computing devices, an indication of a change to at least one of configuration data or tools of the digital preservation system. Processing the indication, at the one or more computing devices, to automatically determine at least one affected asset that is stored by the digital preservation system and is affected by the change, and automatically determining at least one action to be performed by a tool of the preservation system on the at least one affected asset. The at least one action may comprise at least one of: migration of an asset from one format to another format; processing the asset to determine and store properties of the asset; and validation that the asset complies with a format specification for an indicated format of the asset.

The digital preservation system may comprise one or more tools for performing one or more operations on data stored within the digital preservation system (i.e., on content managed by the digital preservation system). The operations may include at least one selected from a list comprising: identification of a format of a file; determination of properties of a file; validation of conformance by a file to a particular file format; migration of a file from one file format to another; validation that a migration from one file format to another has performed successfully; and rendering of content. The indication of a change may comprise an indication of a change to one or more of the tools. The at least one affected asset may comprise a first representation and a second representation. The at least one action may be performed on only one of the first representation and the second representation. For example, the asset may comprise an editable (preservation) representation and an accessible representation and the change may affect only one of the representations. The first representation may comprise an editable representation of the identified asset and the second representation comprises a representation of the identified asset that is intended for presentation. The action may comprise migration of the at least one identified asset. Migration may comprise modifying the identified at least one asset by adding a new representation of data of the asset, the new representation forming a new generation of the asset. Migration of the asset from one format to another format may include migration of the asset from a format defined by a first format specification to a format defined by an updated format specification.

The configuration data of the digital preservation system may comprise a file format database and the indication of a change comprises a change to the file format database. The digital preservation system may comprise a plurality of predetermined preservation actions and the indication of a change comprises an indication of a change to one or more of the plurality of predetermined preservation actions. The digital preservation may comprises one or more user policies and the indication of a change comprises an indication of a change to one or more of the one or more user policies.

The at least one affected asset may be a multi-part asset and the method may further comprise determining a first part of the multi-part asset that is affected by the change and wherein the at least one action is performed only on the first part of the multi-part asset. The method may further comprise determining a second part of the multi-part asset that is affected by the change and performing at least one different action on the second part of the multi-part asset.

The method may further comprise automatically performing the determined at least one action on the at least one affected asset.

There is also described herein one or more non-transitory computer-readable media storing computer-readable instructions configured to cause one or more computing devices to perform any of the methods or steps described herein. For example the instructions may be configured to cause one or more computing devices to receive an indication of a change to at least one of configuration data or tools of the digital preservation system, process the indication to automatically determine at least one affected asset which is stored by the digital preservation system and is affected by the change, and automatically determine at least one action to be performed by a tool of the preservation system on the at least one affected asset, the at least one action comprising at least one of: migration of an asset from one format to another format; processing the asset to determine and store properties of the asset; and validation that the asset complies with a format specification for an indicated format of the asset.

There is also described herein a computing system comprising one or more processors and one or more non-transitory computer-readable media storing computer-readable instructions as set out above.

### BRIEF DESCRIPTION OF THE DRAWINGS

Detailed discussion directed to one of ordinary skill in the art is set forth in the specification, which makes reference to the appended figures, in which:

FIG. 1A depicts a block diagram of an example computing system that

performs novel view rendering according to example embodiments of the present disclosure.

FIG. 2 is block diagram of components of one example of a multi-part asset;

FIG. 3 is a flow diagram depicting a preservation process

FIG. 3 is a flow diagram depicting a preservation process in response to a change to a file format database

FIG. 4 is a flow diagram depicting a preservation process in response to changes to identification, property extraction or validation tools;

FIG. 5 is a flow diagram depicting a preservation process in response to migration tools of the preservation system;

FIG. 6 is a flow diagram depicting a preservation process in response to a change in predetermined preservation actions;

FIG. 7 is a flow diagram depicting a preservation process in response to changes in a preservation policy; and

FIG. 8 is a schematic illustration of an exemplary computer system on which aspects described herein may be implemented.

Reference numerals that are repeated across plural figures are intended to identify the same features in various implementations.

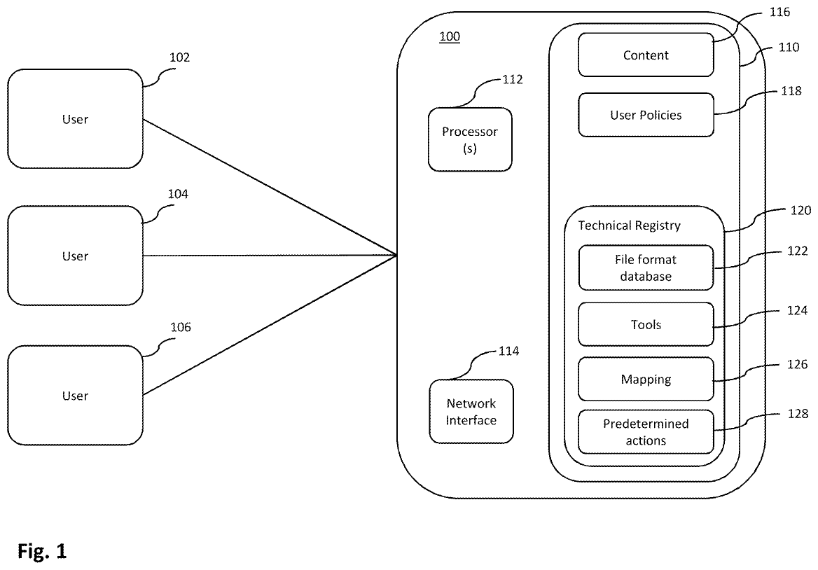

FIG. 1 schematically depicts an example environment in which techniques described herein may be implemented. Preservation system 100 comprises components that enable users 102, 104, 106 to preserve digital content. That is, preservation system 100 provides components configured to operate on digital content to ensure continued access to that digital content. While three users 102-106 are depicted in FIG. 1, it will be appreciated that the preservation system 100 may be used by any number of users. The preservation system 100 comprises storage 110, one or more processors 112 and one or more network interfaces 114. It will be appreciated, however, that where the preservation system 100 is configured to run entirely locally to a user 102-106, the network interface 114 may not be required. The preservation system 100 may comprise other components, not shown in FIG. 1.

Content 116 is stored on storage 110. Generally, the content 116 comprises the content that is managed by the preservation system 100, that is the digital data that is being preserved by the users 102-106. Each user may preserve large amounts of content, for example representing millions of files or data items. The data stored within content 116 may take any form. By way of example only, the content may include documents (such as textual documents, spreadsheets, databases, etc.), images, video, web pages. The content may also include discrete items of data that were incorporated into larger collections of data. For example, the content 116 may include “posts” on internet web pages, such as social media posts (such as forum posts, tweets, etc.), comments on articles, etc. While outside of the digital preservation system 100, content is generally stored in files, within the digital preservation system 100, content stored in content 116 is herein described in terms of assets. While an asset may be fully described by a single file (e.g., an image), other assets may comprise data from more than one file. For example, an email and its attachments may be stored outside the digital preservation system 100 (e.g., at a computing device of a user 102-106) as several files but be represented as a single asset within the content 116 of the digital preservation system 100. As a further example, a “post” on a social media application (such as Twitter®) may include an original post. Each post may include content of a different type (such as images, gifs, video, etc.). Each post and its content may be stored as a single asset. Additionally, each “post” may include one or more replies, each with its own content. Each reply may be stored as a separate asset, linked to the asset of the original post. Alternatively, each reply may be stored as a component of the original asset. An asset that preserves multiple files or parts may be referred to as a multi-part asset.

An asset comprising multiple parts can be identified as conforming to a “representation format”. For example, a “tweet” (i.e., a post made on the social media application Twitter) comprises a JSON data file that conforms to the Twitter API standard and from zero to four images and up to one media (e.g., video) file. If those elements are identified within an asset, the system 100 can determine that the asset represents a tweet. Representation formats may also be validated by examining files and determining whether all expected components are present. For example, a validation process may examine a tweet JSON file, determine that it refers to three images with specific names, are they, and only they, all actually present.

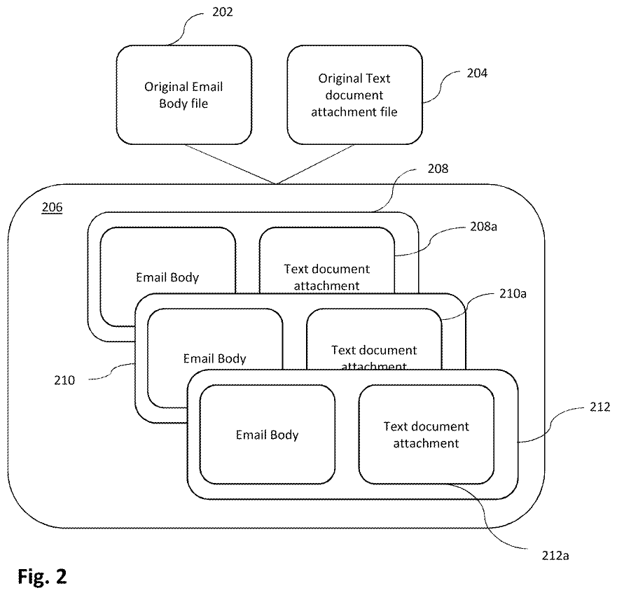

Content 116 may include multiple representations of individual assets. For example, users 102-106 may create different representations of assets for different purposes. For example, a user may create one representation of an asset (e.g., a text document) for preservation purposes (which may be referred to as a digital master) and another representation of the same asset which is accessible to others (for example over the Internet). Advantageously, but not necessarily, the digital master may be an “editable” file while the accessible representation may be a representation that is intended for presentation (rather than editing), such as PDFs. Each representation of an asset may comprise one or more generations corresponding to preservation processes that have been applied to that asset. For example, with reference to FIG. 2, an email received at a user device may be stored in two files at the user device; a first file 202 storing the body of the email and a second file 204 storing an attachment to the email. That email may be stored within the content 116 preservation system as a single asset 206. The asset 206 may comprise first, second and third generations 208, 210, 212 respectively. For example, the original text document attachment file 204 may be a “.wp” file format created and opened with a version of Word Perfect, from Corel Corporation. The first generation 206 may include a component 208a corresponding to the text document attachment. The component 208a may also be stored in the “.wp” format. The second generation 210, which may have been created at a later date, may include a component 210a, again corresponding to the data of the original text document attachment file, but now stored in a “.wp2” format. The third generation 212 may include a component 212a, again corresponding to the data of the original text document attachment file, but now stored in an Open Office Document format (e.g., Open Document Text (.odt)).

Each asset may also include various metadata relating to the files within the asset. Metadata may include an identification of the format of the file and properties of the file. Examples of such properties include number of pages (e.g., where a file is a paged file, such as a text document), number of images, image size, length (time) of audio or length (time) of a video stream. More generally, the properties may be attributes of assets that do not change when a file is migrated from one format to another. For example, a 3 page document will contain 3 pages whether encoded in an ODF format or a PDF format. The metadata may also indicate a current understanding of the formats of files of the assets.

The preservation system 100 also comprises configuration data, including one or more user policies 118. Each user policy 118 may be individual to a particular user 102-106, or multiple users may share a user policy 118. Each user policy 118 comprises rules indicating preferences and actions that a user wishes to be performed by the preservation system 100 and in what circumstances. For example, a user policy 118 may specify, for a particular type of data, one or more target preservation formats (i.e., for the creation of digital masters). A user policy 118 may also include one or more access formats for different types of data. Different target preservation formats and/or access formats may apply to data of the same type in different circumstances. For example, a user policy 118 may specify different target preservation or access formats based on content's access control settings or location in an organisation hierarchy. By way of example only, a user policy 118 of the user 102 may specify a target preservation format for all documents to be the suite of Open Office formats. In this case, documents of any type (e.g., text documents, spreadsheets, presentations, etc) will be preserved in the appropriate Open Office format for that document type. The user policy 118 of the user 102 may also specify creation of PDF versions of all documents to be made available for public access. User policies 118 may be updated by the users 102-106 at any time.

A user policy 118 may include migration rules that specify actions that are to be taken to migrate content that is not received in a target format (either for preservation or access) into the target format. An example migration rule within a user policy 118 may be to specify that Microsoft Word 97-2003 files should be migrated to Open Document Text using a command line tool of LibreOffice from the Document Foundation. Each migration rule may include a definition of the conditions under which it should be applied. For example, a condition may specify that the rule applies only to content having particular characteristics. For example, the characteristics may relate to the properties of the content. Additionally, content 116 may be organised or grouped (e.g., into a folder structure), and conditions may indicate to which parts of the collection of information a particular user policy 118 applies. For example, where the content 116 is arranged into folders, a condition may indicate a top level folder to which a policy 118 applies. This enables different rules to be applied to different parts of the content 116.

A user policy 118 may further include rules about identification, property extraction or validation that is to be performed on content within the preservation system 100. A user policy 118 may further specify one or more predetermined preservation actions 128 (described in more detail below) to which the users of that user policy subscribe. The operations of identification, property extraction and validation may collectively be referred to as “characterisation”. In general, an identification operation may comprise parsing a file and comparing some or all of the parsed file to a dataset of known file formats to discover the most likely format for the file. Property extraction operations may be performed to extract those properties from the file that may be useful for its preservation in the future, to make sure the right actions are performed and to validate any migration actions. Property extraction operations may be performed by a specific tool for the identified file format. Validation operations may be performed to confirm that a file conforms to a file format specification for the file. Characterisation operations may be needed to select among multiple standards to which a file conforms. For example, a Microsoft DOCX file conforms to both the ZIP standard and the DOCX standard. A characterisation operation may determine which standard to apply by using the most specific standard (in this case DOCX). As another example, a Canon Raw 3 image file conforms to the standard for that format and to the standard for MP4. As the Canon Raw 3 is more specific than MP4, the Canon Raw 3 format may be used. In alternative examples, it may be preferred to use the more general format (e.g., ZIP instead of DOCX) instead of the more specific.

The configuration data of the preservation system 100 further comprises data which may be conceptually grouped into a technical registry 120. Generally, the technical registry 120 includes information regarding known file formats and the tools that manage them within the preservation system 100.

The technical registry 120 includes a file format database 122. The file format database 122 comprises a list of all file formats known to the preservation system 100. The file format database may include data that indicates ways in which a particular file format can be identified, e.g., by inspecting the binary content of a file.

The technical registry 120 further includes tools 124, comprising one or more tools for performing actions on files in one or more of the file formats indicated in the file format database. The tools may be stand-alone software tools. An individual tool may be able to perform one or more of the following actions with respect to one or more file formats:

a) Identification of the format of a file;

b) Extraction (or determination) of properties from a file;

c) Validation of whether a file conforms to the format specification of a particular format;

d) Migration of file content from one format to another;

e) Validation that a migration from one format to another has performed successfully; and/or

f) Rendering of content (e.g., to enable a user to interact with the content).

The technical registry 120 includes one or more mappings 126 indicating which of the tools 124 and/or the actions that those tools can perform apply to which of the file formats listed in the file format database 122.

The technical registry 126 may also include one or more predetermined preservation actions 128. The predetermined preservation actions 128 may include indications of preservation actions that may be used with particular file formats and in which circumstances. Users may subscribe to particular predetermined preservation actions. For example, a user may include rules within their user policies to subscribe to one or more of the predetermined preservation actions 128. A plurality of the predetermined preservation actions 128 may be grouped to perform particular migration operations. For example, a predetermined preservation action may specify conversion of all possible textual documents to Portable Document Format (PDF), specifying all file formats that can be converted to PDF and which tools can be used to do so.

The technical registry 120 may further include other tools. The preservation system 100 may comprise a single technical registry 100 to be

shared by one or more users 102-106 of the preservation system 100. Alternatively, the preservation system may include a plurality of technical registries 120, with each technical registry 120 being unique to a single user 102-106, or with one or more of the technical registries 120 shared by more than one of the users 102-106. For example, a technical registry 120 may be shared by several users and its contents managed by an expert Registry Manager on behalf of those users.

The preservation system 100 may be implemented on one or more computing devices. That is, the components shown as part of preservation system 100 may be distributed across any number of computing devices. The preservation system 100 may be accessible to users 102-106 in any appropriate way. For example, preservation system may be provided on a number of servers and accessible to the user 102-106 via the internet. Alternatively, the preservation system 100 may be configured to execute locally to the users 102-106.

Many components of the digital preservation system 100 or the content it manages are subject to change. By way of example only, possible changes that may occur within the technical registry 120 are:

a) New file formats may be added to the file format database 122. For example, as standards develop and new content creation tools are released, new file formats may emerge and these may need adding to the file format database 122.

b) Existing file format definitions within the file format database may be updated. For example, faults or errors may be identified within existing file formats, leading the entries for those formats to be updated.

c) New migration tools may be added to the migration tools 124.

d) Existing migration tools within the migration tools 124 may be updated (e.g., following release of a new version or feature, or a bug fix.

e) Recommended actions may be added to the predetermined preservation actions 128. For example, in response to a new migration tool being added or an existing migration tool being updated to enable migration of content to a newer format, a recommendation may be added to migrate content saved in the older format to the newer format.

f) Recommended actions within the predetermined preservation actions 128 may be changed or removed, for example what a fault is found in a tool.

g) Migration tools may be removed from the migration tools 124, for example if the underlying software is no longer supported or executable within an available operating environment.

A user 102-106 may also make changes to their user policy 120. Example changes include:

i. Changing user defined migrations for digital masters to specify a different target file format;

ii. Removing user defined migrations for digital masters and the corresponding formats changed to “do not migrate”;

iii. User defined migrations to produce a new access copy may be changed to target a new format;

iv. User defined migrations to produce a new access may be removed and the corresponding formats changed to “do not migrate”;

v. The user selected predetermined preservation actions from the predetermined preservation actions 128 may be changed;

vi. The mappings 126 of which migrations apply under which circumstances may be changed.

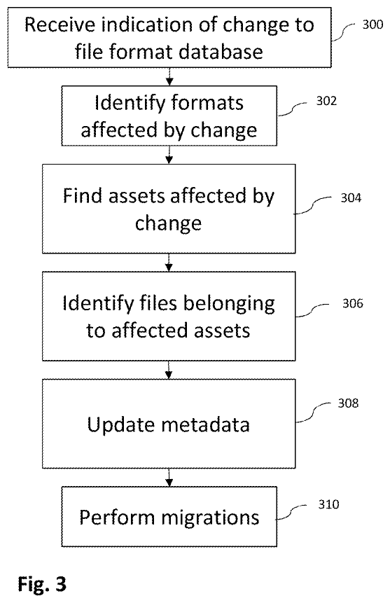

FIG. 3 is an example process that may be applied in response to changes to the file format database 120.

At a step 300, an indication of a change to the file format database 120 is received. For example, the indication of the change may be detection of the change, or notification of the change. The change may be any change to the file format database 120. For example, the change may be addition of an entry or an update/modification of an existing entry.

At step 302, the preservation system 100 may identify file formats affected by the change to the file format database. For example, the preservation system 100 may identify which entries in the file format database have changed and determine the state of those entries prior and subsequent to the change. Identifying file formats affected by the change may comprise receiving a selection of file formats affected by the change. For example, a list of affected file formats may be prepared by a technical expert and input to the preservation system 100 at step 302. Alternatively, the identification may be automatic.

At step 304, the preservation system identifies assets affected by the change to the file format database 122. As part of the processing at step 304, where the preservation system 100 has a plurality of users and a subset of those users are subscribed to the technical registry 120, the preservation system 100 may determine which users of the plurality of users are presently subscribed to the technical registry 120 in order to determine the assets of those users that are affected by the change. Identification of assets affected by the change may include identification of assets including files originally preserved in a format(s) affected by the change (as determined at step 302), or where migrations have created subsequent generations with files stored in those format(s). It will be appreciated that where the change was simply the addition of a new format and where there have been no concurrent policy or recommendation changes associated with the new format, it may be the case that no existing intellectual assets are affected by the change.

At step 306, the preservation system 100 identifies files within the affected assets identified at step 304. At step 308, metadata for the identified files is updated where necessary. For example, where a format of an identified file has changed as a result of the change identified at step 300, this change may be recorded in metadata to provide a history of format changes for the file. In addition, property extraction and validation processes may be executed on the file and updated properties saved in metadata.

At step 310, for each file identified in step 306, the updated format for that file is compared with the user policy 118 and/or predetermined preservation actions 128 of the user for whom that file is being managed. Where the file within an asset requires migration as a result of the change, a migration process is performed to bring the file into line with the user policy 118 and/or the updated file format. As described with reference to FIG. 2, the migration may result in a new generation being added to an asset to which the identified file belongs. Any redundant data may be deleted. For example, where multiple generations are not to be retained, older versions may be removed. Alternatively, where the change identified at step 302 was due to an error identified in a previously performed migration action, it may not be necessary or desired to retain files created as a result of the previous migration action. In this case, the method may further comprise deleting older versions of newly migrated assets.

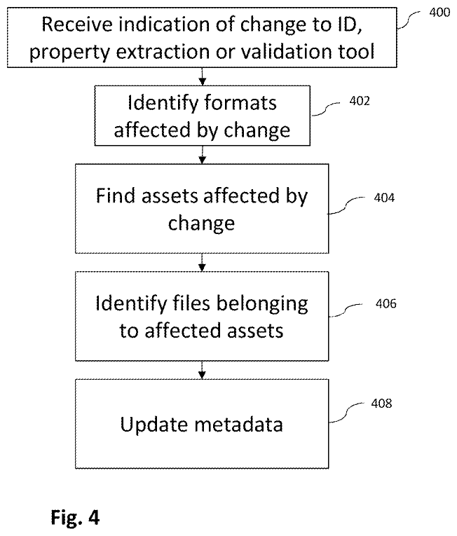

FIG. 4 is a flowchart depicting a process that may be carried out in response to a change in one of the identification, property extraction or validation tools in the tools 124. A change to one of these tools may occur, for example, in response to a change in a property extraction policy for a particular file format, addition of a new tool, or in response to updating of an existing tool within the tools 124.

At step 400, the preservation system 100 receives an indication of a change to one of the tools 124. While not shown in FIG. 4, the processing of step 400 may include a determination as to whether a re-extraction of properties is required in response to the change. For example, where a tool has been updated with a newer version to improve stability of the tool itself, it may be determined that re-extraction of properties is not required. If it is determined that re-extraction of properties is not required, the remaining steps of FIG. 4 would not be performed.

At step 402, the preservation system 100 identifies file formats affected by the change to the tool. For example, the preservation system 100 may identify which entries in the file format database for which properties were extracted or validation was carried out using an older version of the tool. Identifying file formats affected by the change may comprise receiving a selection of file formats affected by the change. For example, a list of affected file formats may be prepared by a technical expert and input to the preservation system 100 at step 402. Alternatively, the identification may be automatic.

At step 404 the preservation system 100 identifies assets affected by the change. As part of the processing at step 404, where the preservation system 100 has a plurality of users and a subset of those users are subscribed to the technical registry 120, the preservation system 100 may determine which users of the plurality of users are presently subscribed to the technical registry 120 in order to determine the assets of those users that are affected by the change. Determining the assets affected by the change may include determining which assets include files in the format(s) identified at step 402. It will be appreciated that where the change was simply the addition of a tool (e.g., for extracting properties of a new file format) or where the change is not expected to have an impact on the results of any previous property extraction operations, it may be the case that no existing assets are affected by the change.

At step 406, the preservation system 100 identifies the files within the assets identified at step 404. At step 408, the preservation system 100 performs a format identification process on the identified files, to ensure that the file was correctly identified in the metadata associated with that file. Where the existing identification is correct, the preservation system 100 performs property extraction and validation using the updated tool and saves the results to the metadata associated with the file.

Where an existing identification is identified as being incorrect, the new, corrected, format is saved in metadata and the property and validation processes are repeated using the tools associated with the newly identified format. For files that were incorrectly identified in their metadata, when the correct properties have been extracted, the files may be compared against the user policy, and any necessary migrations performed, as described with reference to step 310 above.

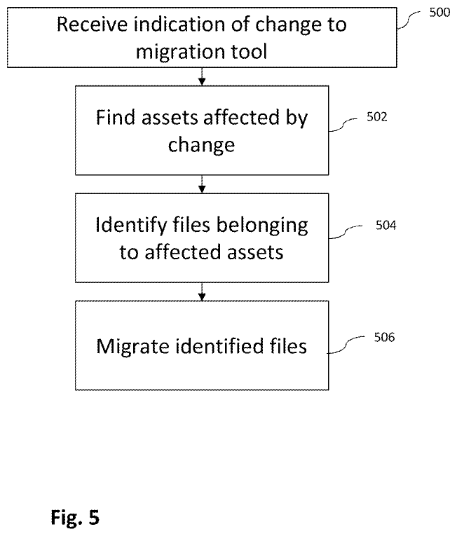

FIG. 5 is a flowchart depicting an example process that may be carried out in response to a change to one or more of the migration tools of the tools 124 of the preservation system 100.

At step 500, the preservation system 100 receives an indication of a change to a migration tool. Changes to migration tools may be made when updated software is released or a tool configuration is changed. While not shown in FIG. 5, the processing of step 500 may include a determination as to whether a re-migration (i.e., executing the migration tool on existing assets) is required in response to the change. For example, where a tool has been updated with a newer version to improve stability of the tool itself, it may be determined that re-migration is not required. If it is determined that re-migration is not required, the remaining steps of FIG. 5 would not be performed.

In some implementations a re-migration may also not be performed until a recommendation is added to the predetermined preservation actions 128, and/or until a change is made to a user policy 118 to indicate that the new tool should be used. As such, in some implementations, the processing at step 500 may be a determination that a recommendation 128 has been added or modified

In some cases, however, re-migration is required, for example because of a bug in the previous version of the migration tool resulting in poor quality, or faulty migrations. Where re-migration is required, at step 502 the preservation system 100 identifies assets that were subject to a migration operation using the affected migration tool. For example, this may be specific assets that are impacted by the change or may be all formats that the tool is capable of migrating.

As part of the processing at step 502, where the preservation system 100 has a plurality of users and a subset of those users are subscribed to the technical registry 120, the preservation system 100 may determine which users of the plurality of users are presently subscribed to the technical registry 120 in order to determine the assets of those users that are affected by the change. Determining the assets affected by the change may include determining which assets include files in particular format(s) affected by the change. It will be appreciated that where the change was simply the addition of a tool and where there have been no concurrent policy or recommendation changes associated with the new format, it may be the case that no existing intellectual assets are affected by the change.

At step 504, the preservation system identifies files belonging to the affected assets and at step 506 migrates the identified files using the new (or newly updated) migration tool. The new file, whether a new generation or a new representation (as described above) is saved. Any files that are no longer needed (such as previous versions of files or generations) may be marked as redundant and optionally deleted.

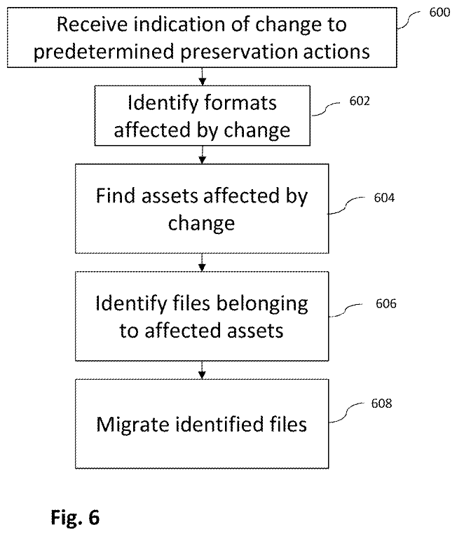

FIG. 6 is a flowchart depicting an example process that may be performed in response to a change in the predetermined preservation actions 128. Recommendation changes may occur when new predetermined preservation actions become appropriate due to environment changes (such as a content creation/editing tool or format falling out of use), when it becomes possible to migrate new formats, or when errors are detected that mean existing predetermined preservation actions need to be withdrawn. Predetermined preservation actions may be updated manually, e.g., by a Registry Manager, or may in some implementations be updated automatically.

At step 600 the preservation system 100 receives an indication of a change to the predetermined preservation actions 128. At step 602 the preservation system 100 identifies formats affected by the change. Identifying file formats affected by the change may comprise receiving a selection of file formats affected by the change. For example, a list of affected file formats may be prepared by a technical expert and input to the preservation system 100 at step 602. Alternatively, the identification may be automatic. The formats may include specific formats relevant to the change in the predetermined preservation actions and/or all formats specified in the changed predetermined preservation action.

At step 604 the preservation system detects which assets are affected by the change. As part of the processing at step 604, where the preservation system 100 has a plurality of users and a subset of those users are subscribed to the technical registry 120, the preservation system 100 may determine which users of the plurality of users are presently subscribed to the technical registry 120 in order to determine the assets of those users that are affected by the change. Determining the assets affected by the change may include determining which assets include files in the format(s) identified at step 602. Determining which assets are affected by the change may involve identifying assets that have used a recommendation that has been changed. It will be appreciated that in some instances, there may be no assets affected by the change in which case processing may end at step 604.

Where there are one or more assets affected by the change, processing passes to step 606 and the preservation system identifies files of the assets identified at step 604. At step 608, the preservation system migrates the identified files using the new or modified recommendation. The new file, whether a new generation or a new representation is saved. Any files that are no longer needed (such as previous versions of files or generations) may be marked as redundant and optionally deleted.

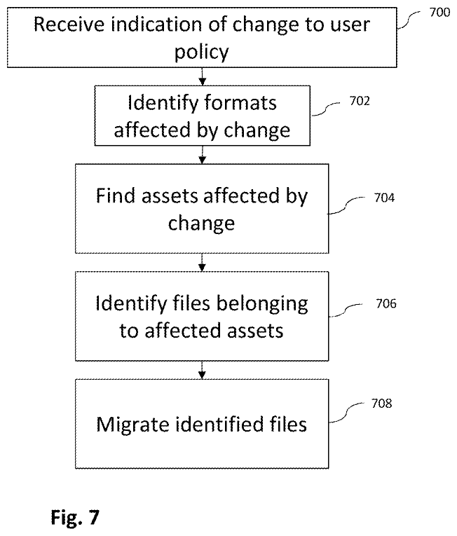

FIG. 7 is a flowchart depicting an example process that may be performed in response to a change to a user policy 118. Such changes may include addition to, updating or removal of predetermined preservation actions 128 the user chooses to implement. Alternatively or additionally, changes to user policies may also include addition, modification or removal of a manually defined mapping of what migration should apply to files of a given format. Alternatively or additionally, changes to user policies may include changes to conditions under which subscribed predetermined preservation actions and/or manual mappings of format to migration should be applied. For example, an example condition may, for example, indicate indicate that a particular policy should be applied to a test folder, that a determination should be made that the action executed correctly, and if so that the policy should then be applied to a larger dataset. At step 700, the preservation system 100 receives an indication of a change to a user policy. At step 702, the preservation system 100 identifies any assets affected by the change, for example those assets having files of a format identified at step 702. At step 704 the preservation system 100 identifies assets affected by the change. For example, the preservation system may identify assets having files of a format identified at step 702. The preservation system 100 then identifies files of the determined assets that need migration as a result of the change to the user policy and migrates those files at step 708. The new file, whether a new generation or a new representation is saved. Any files that are no longer needed (such as previous versions of files or generations) may be marked as redundant and optionally deleted.

There have been described above processes to enable the preservation system 100 to automatically respond to changes that may affect preservation of data managed by the preservation system. It will be appreciated that while various processes have been described as including a number of discrete steps, the ordering of these steps may be changed or steps may be combined. For example, while it is described above that the preservation system 100 may, in various processes, identify formats, then assets and then particular files within the assets, it will be appreciated that the identification of files within assets may be identified according to any appropriate process. For example, in some implementations the preservation system may receive (rather than actively identifying) an indication of which file formats are affected by a change and using that information may be able to identify affected files of assets, without an intermediate step.

As described above with reference to FIG. 2, an asset may be multi-part, in that it comprises more than one file. Some migration actions may result in a change in the number of files that an asset contains. For example, an image that is saved in a TIFF image format that contains multiple pages could be migrated into individual JPEG format files. As such, in the processing described above with reference to any one of FIGS. 3 to 7, processing may be performed to determine whether a change causes or should cause a single file to be migrated to multiple files, or vice versa. For example, with reference to FIG. 7, the processing at step 706 may include processing to determine whether migration of any of identified files will result in a change in the number of files. In response to determining, for example, that a single file will be migrated to multiple files, adequate storage may be reserved for the multiple files. As another example, migration actions may result in multiple files being merged into a single asset. It will also be appreciated that while FIG. 1 depicts three users and FIG. 2 depicts a single asset, in practice the number of users will likely be larger, while the number of files/assets will be significant (for example millions). Similarly, while the preservation system 100 is depicted as a single entity, it will be appreciated that the preservation system may be implemented over multiple servers. As such, in some embodiments, the preservation system 100 may adopt approaches to improve searching performance. For example, when identifying assets and files that are affected by a particular change (in any of the processing described above with reference to FIGS. 3 to 8), the preservation system may search for those assets in a way that rules out those that are not affected early in the search process.

The preservation system 100 may additionally implement one or more queues for assets that need further processing (such as migration, property extraction and/or validation as discussed above with reference to FIGS. 3 to 8). Queues, operations and/or assets may be prioritized to ensure that backlogs do not prevent day-to-day processes like ingest and download of files into the preservation system 100.

The preservation system 100 may further make use of process sharing between users to ensure one large user does not monopolize all the processing resources of the particular server, thereby preventing other users of that server from effective use of the preservation system 100.

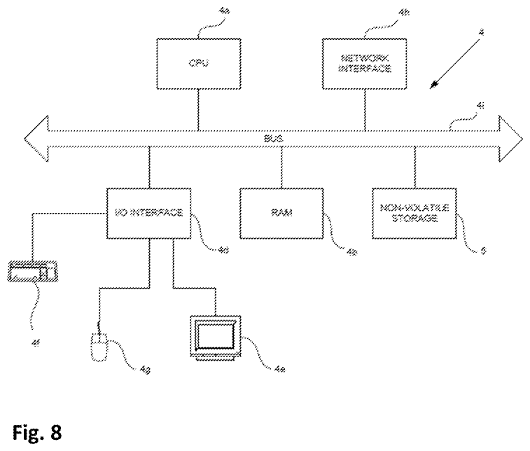

FIG. 8 schematically illustrates an exemplary arrangement of components which may provide a computing system 4 used to implement all or part of the preservation system 100 or a computing device of a user 102-106.

A processor, in this case in the form of a CPU 4a, configured to read and execute instructions stored in a volatile memory 4b which takes the form of a random access memory. The processor 4a may be one of one or more processors 112. It will be appreciated that the processor may take other forms, such as, for example, a GPU. The volatile memory 4b stores instructions for execution by the CPU 4a and data used by those instructions. For example, the instructions may include instructions for causing the preservation system 100 to carry out the processing described above with reference to any of FIGS. 3 to 7.

The computing system 4 comprises a storage device 5. It will be appreciated that the storage device 5 may be implemented in any way, such as for example, a hard disk drive, a solid state drive, etc. The storage device 5 may provide the storage 110. The computing system 4 further comprises an I/O interface 4d to which are connected peripheral devices used in connection with the computing system. More particularly, a display 4e is configured so as to display output. Input devices are also connected to the I/O interface 4d. Such input devices include a keyboard 4f and a mouse 4g which allow user interaction with the computing system 4. A network interface 4h allows the computing system 4 to be connected to appropriate computer networks, such as the Internet 6, and so as to be able to send and receive from and to other computing devices such as computing devices of the users 102-106 (where the computing system 4 provides the preservation system 100) or to the preservation system 100 (where the computing system 4 provides a user device). The network interface 4h may provide the network interface 114. The CPU 4a, volatile memory 4b, the storage device 5, I/O interface 4d, and network interface 4h, are connected together by a bus 4i.

The techniques described above may be implemented in hardware, firmware, software, or any combination thereof. The techniques may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc. and in doing that may cause actuators or other devices to interact with the physical world.

While specific embodiments of the invention have been described above, it will be appreciated that the invention may be practiced otherwise than as described. The descriptions above are intended to be illustrative, not limiting. Thus, it will be apparent to one skilled in the art that modifications may be made to the invention as described without departing from the spirit of the invention.

1. A computer-implemented method of automatically preserving digital documents stored in a digital preservation system, comprising, at one or more computing devices:
receiving an indication of a change to at least one selected from a group consisting of configuration data and tools of the digital preservation system;
processing the indication to automatically determine at least one affected asset which is stored by the digital preservation system and is affected by the change;
automatically determining at least one action to be performed by a tool of the preservation system on the at least one affected asset, the at least one action comprising at least one selected from a group consisting of:
a) migration of the at least one affected asset from one format to another format, and
b) processing the at least one affected asset to determine and store properties of the at least one affected asset; and
automatically performing the determined at least one action on the at least one affected asset.

2. The computer-implemented method of claim 1, wherein the digital preservation system comprises one or more tools for performing one or more operations on data stored within the digital preservation system, the operations including at least one selected from a group consisting of: identification of a format of a file; determination of properties of a file; validation of conformance by a file to a particular file format; migration of a file from one file format to another; validation that a migration from one file format to another has performed successfully; and rendering of content.

3. The computer-implemented method of claim 2, wherein the indication of a change comprises an indication of a change to one or more of the tools.

4. The computer-implemented method of claim 1, wherein the at least one affected asset comprises a first representation and a second representation; and
wherein the at least one action is performed on only one of the first representation and the second representation.

5. The computer-implemented method of claim 4, wherein the first representation comprises an editable representation of the identified asset and the second representation comprises a representation of the identified asset that is intended for presentation.

6. The computer-implemented method of claim 4, wherein the at least one action comprises migration of the at least one identified asset;
wherein migration comprises modifying the identified at least one asset by adding a new representation of data of the asset, the new representation forming a new generation of the asset.

7. The computer-implemented method of claim 1, wherein the configuration data of the digital preservation system comprises a file format database and the indication of a change comprises a change to the file format database.

8. The computer-implemented method of claim 1, wherein the digital preservation system comprises a plurality of predetermined preservation actions and the indication of a change comprises an indication of a change to one or more of the plurality of predetermined preservation actions.

9. The computer-implemented method of claim 1, wherein the digital preservation system comprises one or more user policies and the indication of a change comprises an indication of a change to one or more of the one or more user policies.

10. The computer-implemented method of claim 1, wherein the at least one affected asset is a multi-part asset and the method further comprises:
determining a first part of the multi-part asset that is affected by the change and wherein the at least one action is performed only on the first part of the multi-part asset.

11. The computer-implemented method of claim 10, further comprising determining a second part of the multi-part asset that is affected by the change and performing at least one different action on the second part of the multi-part asset.

12. The computer-implemented method of claim 1, further comprising validating whether the at least one asset complies with a format specification for an indicated format of the at least one affected asset.

13. One or more non-transitory computer-readable media storing computer-readable instructions configured to cause one or more computing devices to:
receive an indication of a change to at least one selected from a group consisting of configuration data and tools of the digital preservation system;
process the indication to automatically determine at least one affected asset which is stored by the digital preservation system and is affected by the change;
automatically determine at least one action to be performed by a tool of the preservation system on the at least one affected asset, the at least one action selected from a group consisting of:
a) migration of the at least one affected asset from one format to another format, and
b) processing the at least one affected asset to determine and store properties of the at least one affected asset;
automatically perform the determined at least one action on the at least one affected asset.

14. The one or more non-transitory computer-readable media of claim 13, wherein the at least one affected asset is a multi-part asset and the instructions are configured to further cause the one or more computing devices to:
determine a first part of the multi-part asset that is affected by the change and wherein the at least one action is performed only on the first part of the multi-part asset.

15. The one or more non-transitory computer-readable media of claim 14, wherein the instructions are configured to further cause the one or more computing devices to determine a second part of the multi-part asset that is affected by the change and perform at least one different action on the second part of the multi-part asset.

16. The one or more non-transitory computer-readable media of claim 13, wherein the instructions are configured to further cause the one or more computing devices to validate whether the at least one affected asset complies with a format specification for an indicated format of the at least one affected asset.

17. A computing system comprising:
one or more processors;
one or more non-transitory computer-readable media storing computer-readable instructions configured to cause one or more processors to:
receive an indication of a change to at least one selected from a group consisting of configuration data and tools of the digital preservation system;
process the indication to automatically determine at least one affected asset which is stored by the digital preservation system and is affected by the change;
automatically determine at least one action to be performed by a tool of the preservation system on the at least one affected asset, the at least one action selected from a group consisting of:
a) migration of the at least one affected asset from one format to another format,
b) processing the at least one affected asset to determine and store properties of the at least one affected asset, and
c) validation that the at least one affected asset complies with a format specification for an indicated format of the at least one affected asset; and
automatically perform the determined at least one action on the at least one affected asset.

18. The computing system of claim 17, wherein the at least one affected asset is a multi-part asset and the instructions are configured to further cause the one or more processors to:
determine a first part of the multi-part asset that is affected by the change and wherein the at least one action is performed only on the first part of the multi-part asset.

19. The computing system of claim 18, wherein the instructions are configured to further cause the one or more processors to determine a second part of the multi-part asset that is affected by the change and perform at least one different action on the second part of the multi-part asset.

20. The computing system of claim 17, wherein the configuration data of the digital preservation system comprises a file format database and the indication of a change comprises a change to the file format database.
